(19) United States
(12) Patent Application Publication
(10) Pub. No.: US 2008/0313350 A1
(43) Pub. Date: Dec. 18, 2008

(54) METHOD AND SYSTEM OF CACHE DISCOVERY IN A PEER-TO-PEER ENVIRONMENT

(75) Inventors: Jeffrey H. Swinton, Ashburn, VA (US); Douglas M. Pasko, Bedminster, NJ (US)

Correspondence Address: VERIZON;PATENT MANAGEMENT GROUP, 1515 N. COURTHOUSE ROAD, SUITE 500, ARLINGTON, VA, 22201-2909, US

(73) Assignee: Verizon Services Organization Inc., Irving, TX (US)

(21) Appl. No.: 11/764,455

(22) Filed: Jun. 18, 2007

(51) Int. Cl. G06F 15/173

(52) U.S. Cl. 709/240; 709/241

(57) ABSTRACT

An approach is provided for cache discovery in a peer-to-peer system. A request is received from a peer node based on a network address assigned to a plurality of network caches, wherein the peer node is configured to operate in a peer-to-peer environment. In response to the request, a closest one of the network caches is determined based on a closest instance of a network address.

### BACKGROUND OF THE INVENTION

Peer-to-peer (P2P) systems have emerged as a viable approach for file sharing and supporting exchange of information. These systems comprise a collection of computing nodes that possess equal capabilities and can directly communicate to share files or other media objects. In general, P2P systems are classified as a pure P2P or a hybrid P2P system. Under pure P2P model, all nodes are equal and may function as client or server. Thus, no central server is utilized. Under the hybrid P2P model, a set of servers is maintained for storing information. P2P systems minimize the problem of potentially overloading a particular content server (in a client/server architecture) as the number of requesting nodes increase, as identical content can exist across multiple servers. With the P2P architecture, system capacity increases as more peer nodes are introduced into the system.

Service providers have come to recognize the benefit of supporting a P2P environment. However, these service providers face the challenge of optimizing their networks to ensure reliable and timely delivery of traffic. Under the hybrid model, the service provider is generally encumbered with the management of network resources, such as network caches.

Therefore, there is a need for an approach for providing efficient management of network resources in a P2P environment.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a peer-to-peer (P2P) system capable of providing cache discovery, according to an exemplary embodiment;

FIG. 2 is a diagram of a process for utilizing Anycast to access a network cache, according to various exemplary embodiments;

FIG. 3 is a diagram of a system including a plurality of service provider networks capable of providing P2P cache discovery, according to an exemplary embodiment;

FIG. 4 is a flowchart of a process for providing P2P cache discovery, according to an exemplary embodiment;

FIG. 5 is a flowchart of a process for assigning addresses to the network caches of the system of FIG. 1, according to an exemplary embodiment;

FIG. 6 is a flowchart of a process for controlling access to the network caches of FIG. 1, according to an exemplary embodiment; and

FIG. 7 is a diagram of a computer system that can be used to implement various exemplary embodiments.

### DESCRIPTION OF THE PREFERRED EMBODIMENTS

A system, method, and software for providing peer-to-peer cache discovery are described. In the following description, for the purposes of explanation, numerous specific details are set forth in order to provide a thorough understanding of the present invention. It is apparent, however, to one skilled in the art that the various exemplary embodiments may be practiced without these specific details or with an equivalent arrangement. In other instances, well-known structures and devices are shown in block diagram form in order to avoid unnecessarily obscuring the exemplary embodiments.

Although the various exemplary embodiments are described with respect to a hybrid peer-to-peer (P2P) environment and the Internet Protocol (IP) Anycast protocol, it is contemplated that these embodiments have applicability to other P2P systems and any equivalent protocols.

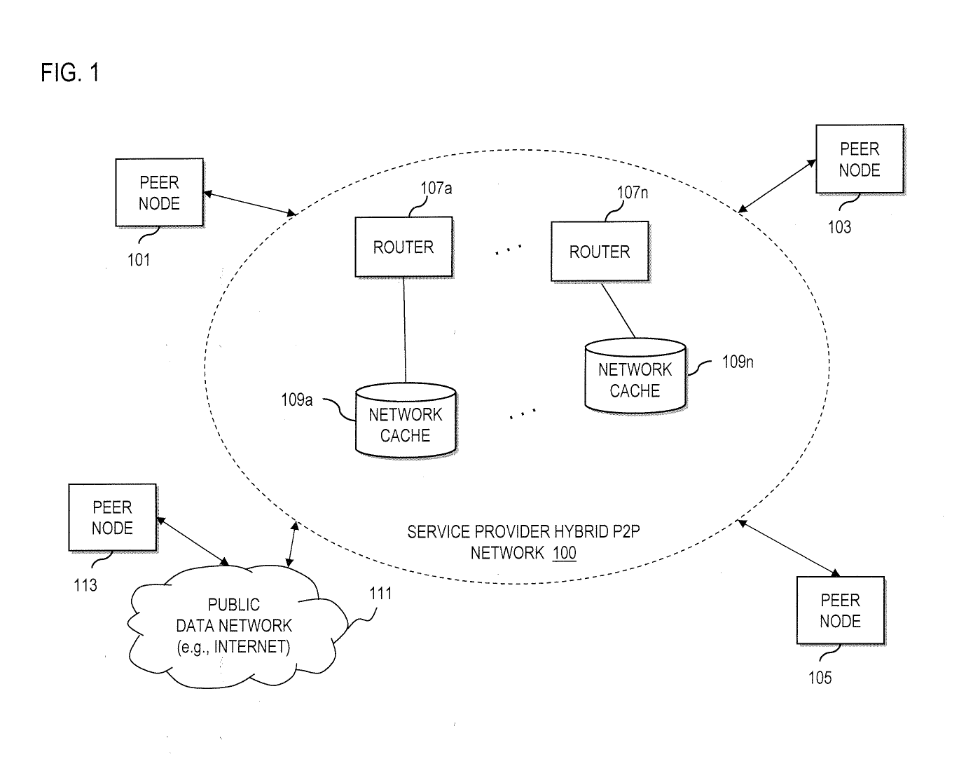

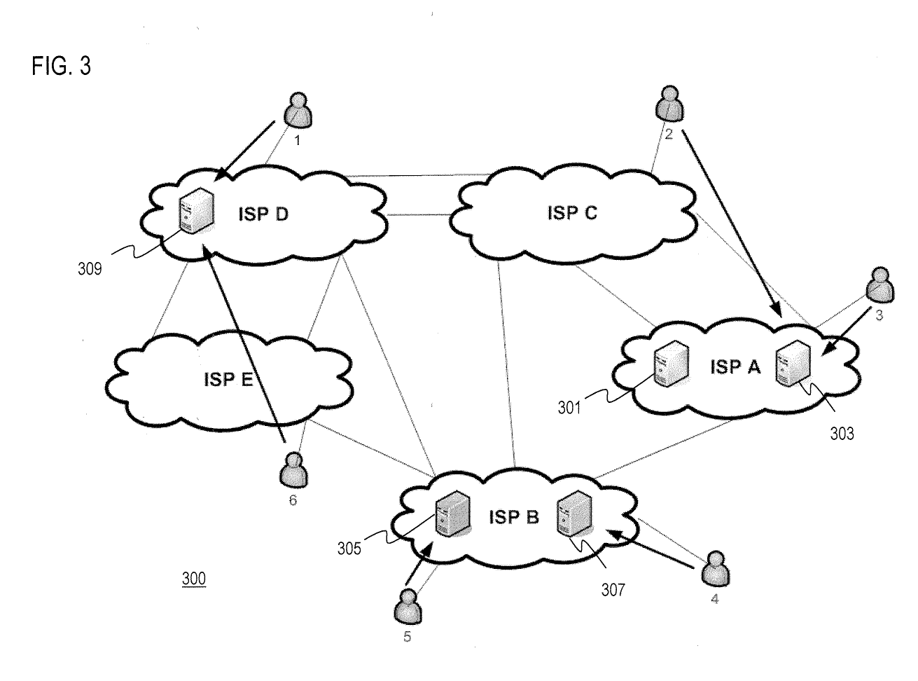

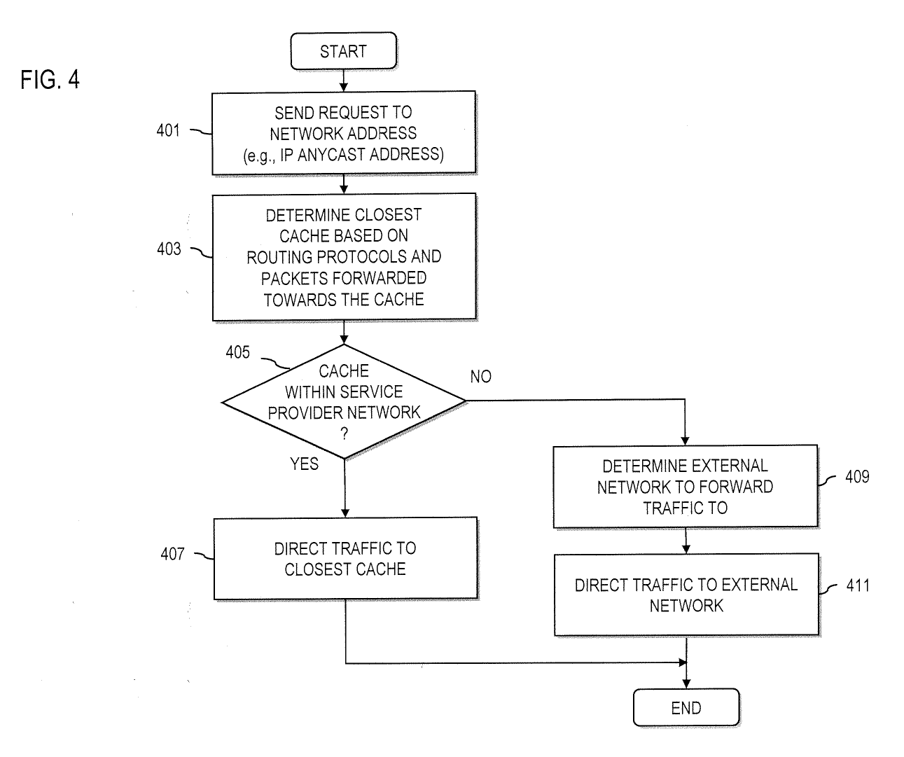

FIG. 1 is a diagram of a peer-to-peer (P2P) system capable of providing cache discovery, according to an exemplary embodiment. For the purposes of illustration, a communication system 100 employs a hybrid P2P architecture using the Anycast protocol, in which peer nodes 101, 103, and 105 communicate, using communication paths established over one or more routers 107a-107n, with network caches (or servers) 109a-109n. In addition to the content resident within the peer nodes, network caches 109a-109n are deployed to store content, as to improve network performance and reliability. As used herein, a server/host/computer is a machine that stores and distributes content; a router forwards information to an intended target or destination. That is, servers send and receive content (creation), and routers deliver that content to where it is intended (distribution). Each router 107a-107n has an entry that specifies how to reach the network caches 109a-109n using a corresponding network address (e.g., IP Anycast address). Assuming peer node 101 seeks to communicate with a network cache, the network 100 determines which cache 109a-109n can serve this peer node 101. For instance, the network cache 109a is selected, in which case, a communication path is established using router 107a. However, if the network 100 selects network cache 109n, then the peer node 101 would utilize a communication path that involves router 107a and router 107n, which is connected to cache 109n. Thus, a particular network cache can be directly connected to a router, or be reached through another router, depending on the connectivity of the requesting peer node. It is noted that the routers 107a-107n have no knowledge that there are multiple caches 109a-109n in the network 100. As will be more fully described below (with respect to FIGS. 3 and 4), such knowledge is not necessary, as the traffic is sent to the “closest” one.

Additionally, the P2P architecture has the capability to self-organize; as part of this function, the addition of peers to the network 100 does not entail re-organization of the peer nodes.

By way of example, the network caches 109a-109n can be maintained by an individual or a service provider (as in the scenario of FIG. 3). Moreover, such service provider can be an Internet Service Provider (ISP), which has communication service offerings for connectivity to the global Internet. As noted, a challenge to providing a P2P hybrid offering is the management of the network based clients (or caches) 109a-109n. These caches 109a-109n are used to improve performance and reliability for the P2P network 100. Without these devices 109a-109n, it would be possible for a peer node (e.g., 101) to request a file that does not exist on-line at that time. The caches 109a-109n, for example, can help such a scenario, but they can also help users from having to cover great distances to obtain certain files. The caches 109a-109n could be much closer to the end user, and thus reduce the bandwidth consumed and increase performance.

For a global implementation, tens or hundreds of different caches can be utilized within the network 100 and across a public data network 111, such as the Internet. As shown, a peer node 113 can exist anywhere within the Internet 111. With respect to the numerous caches 109a-109n, managing a list of the caches 109a-109n and more importantly which caches are appropriate for each peer node 101-105 is a daunting task. Moreover, the ISP may wish to restrict access to the network caches 109a-109n to only subscriber nodes 101-105—that is, not for global use.

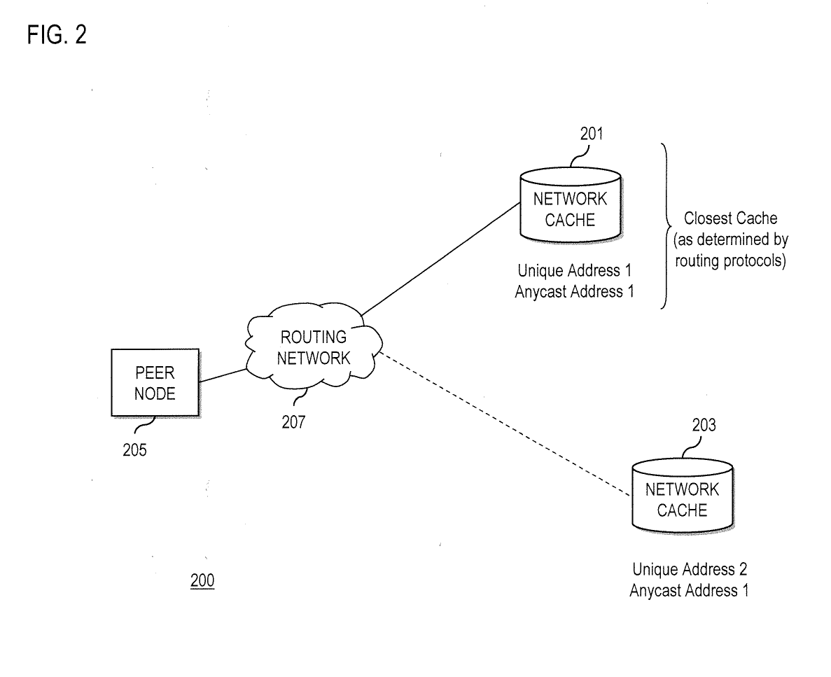

To address these challenges, the network 100, according to certain embodiments, utilize a cache discovery mechanism that exploits an addressing scheme that provides a single network address (e.g., Internet Protocol (IP) address) to represent the closest cache irrespective of where the requesting peer node is located. According to one embodiment, the P2P network 100 uses IP Anycast as the addressing scheme, which is explained below in FIG. 2.

FIG. 2 is a diagram of a process for utilizing Anycast to access a network cache, according to various exemplary embodiments. IP Anycast provides a network addressing and routing scheme to determine the “closest” (i.e., “nearest” or “best”) cache based on the routing topology. Anycast assigns the same IP address to multiple caches 201 and 203. In this example, the cache 201 is assigned the following addresses: “Unique Address 1” and “Anycast Address 1.” The cache 203 has addresses of “Unique Address 2” and “Anycast Address 1.” Under the Anycast method, a one-to-many association between network addresses and network endpoints exists (as with multicast and broadcast techniques). Unlike multicast and broadcast, the address identifies receiver endpoints, in which one receiver is selected at a given time to receive the traffic.

While this address assignment appears to violate one of the early mandates of IP addressing (i.e., the IP addresses need to be unique), Anycast provides for a peer node 205 sending a request to a single IP address, and relies on the network (e.g., a routing network 207) to determine which cache (of potentially hundreds or thousands) is deemed to be the closest with respect to the peer node 205 using the network's native routing protocols (e.g., Border Gateway Protocol (BGP), Intermediate System-Intermediate System (IS-IS), Open-Shortest Path First (OSPF), etc.).

By configuring all of the caches 201 and 203 with the same IP address, the peer node 205 can be configured with a single IP address that represents the closest cache.

FIG. 3 is a diagram of a system including a plurality of service provider networks capable of providing P2P cache discovery, according to an exemplary embodiment. Under this scenario, multiple Internet Service Providers (ISPs) (A-E) are part of a P2P environment 300 (e.g., within the global Internet) and can communicate using various connections and topologies. Each of the ISPs serves its corresponding subscribers 1-6. Notably, ISP A directly serves subscriber 3, while ISP B provides service to subscribers 4 and 5. ISP C has user 2 as a subscriber. ISP D serves subscriber 1, and ISP E serves subscriber 6. In this example, ISP A maintains network caches 301 and 303. Network caches 305 and 307 are part of ISP B's network. Also, ISP D provides network cache 309. ISPs C and E do not maintain any caches.

As shown, client 2 is directed to cache 303 because cache 303 is deemed to be the closest cache. ISP C determines whether it is closer to send the request to ISP D or ISP A. If ISP A is chosen, then ISP A determines the best or closest cache, which in this example is network cache 303. Network routers are utilized for supporting the determination of this closest cache, through the use of an appropriate Anycast address. According to one embodiment, the routing function sends packets along the shortest path to their destination through the use of a routing protocol (e.g., BGP, IS-IS, OSPF, etc.). In this case, multiple destinations exist, with multiple paths (this is transparent to the routers, as the routers are not aware of the multiple destinations).

To provide the capability to control access to the network caches, the ISPs decide whether the Anycast address should be announced. Namely, they may send the address to customers, but not to other ISPs for instance. Traditionally, this capability to control access would either require very complex rules to be installed on the end users computers, or all of the clients be connected to a central location to manage all caches that exist as well as which caches would be best to use. For example, users may require different configurations for their computers depending on their locations, e.g., home, work, or the local coffee shop. The approach of FIG. 3 avoids this configuration issue.

Functionally, by using the same IP addresses for all of the P2P caches deployed across the communication system (e.g., Internet), the configuration of the end user devices is simplified. According to an exemplary embodiment, all end user devices can thus be configured with the same cache IP address no matter where on the Internet they are attached.

If an ISP decides to offer caches for their customers and not the whole Internet it is just a matter of adjusting the announcement of the route for the cache IP address. As explained, ISP B houses caches 305 and 307 that are for use only by customers, users 4 and 5, of ISP B. ISPs A and D maintain caches 301, 303 and 309 for the entire system 300, whereby these network resources are available to all users 1-6. The bold lines indicate which cache the user will be directed to. In this example, user 6 might actually be best off by being directed to ISP B, however with the decision of ISP B to not announce the route for the caches 305 and 307 to the outside world, ISP E does not even “see” those caches 305 and 307 as an option. Various methods can be employed for announcing or preventing this route from being announced to other ISPs. One method, for instance, is to use a “no-export” BGP community; however, other equivalent approaches may be implemented.

The above approach provides a hybrid delivery mechanism that increases performance and reliability of the provider networks by reducing the complexity of cache management and end user device (e.g., client) management. This approach also controls access to each cache and ensures selection of the “best” cache. The operation of how such network caches are discovered and utilized is further detailed below with respect to FIGS. 4-6.

FIG. 4 is a flowchart of a process for providing P2P cache discovery, according to an exemplary embodiment. Continuing with the example of FIG. 3, when a user (e.g., subscriber 3) attempts to connect to a cache, e.g., cache 303, the user, via an end user device, sends a request to the network address (e.g., IP Anycast address) for access to a network cache, per step 401. In step 403, the ISP A then determines which cache is the closest or best based upon their routing protocols and the packets that are forwarded towards the particular cache. If there is a cache within the ISP's network, as decided in step 405, then the ISP's network determines the closest cache using, for example, their internal routing protocols (e.g., Interior Gateway Protocol (IGP)). The traffic is directed accordingly, as in step 407. If there is not a cache on the ISPs network, then the network utilizes an external routing protocol (e.g., Border Gateway Protocol (BGP)) to determine which external network to forward the traffic to, and direct such traffic to such destination, per steps 409 and 411.

The above process is effective because of the use of an Anycast address for the network cache 303. However, as explained in FIG. 2, this is not the only IP address assigned to the cache 303, as a unique IP address is also assigned. As such, the network cache 303 can be managed remotely from anywhere on the system 300.

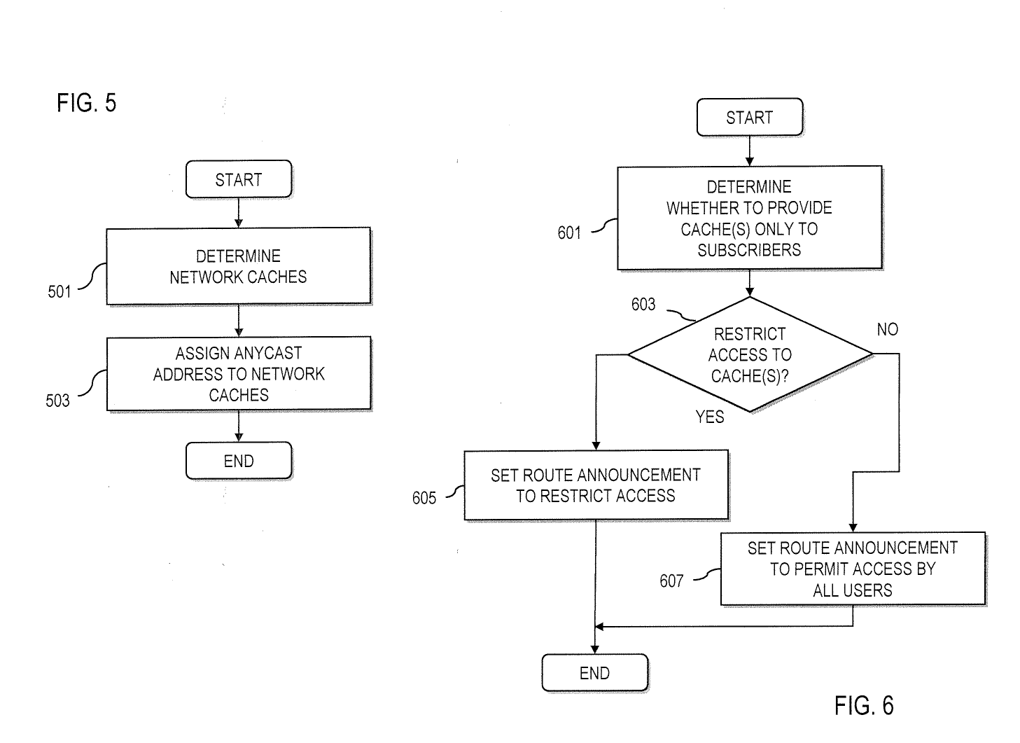

FIG. 5 is a flowchart of a process for assigning addresses to the network caches of the system of FIG. 1, according to an exemplary embodiment. Assuming the network caches 109a-109n are under the control of a single P2P provider, this provider can determine all the network caches that within its network (step 501). In an exemplary embodiment, the network caches 109a-109n are assigned, as in step 503, an Anycast address using the Anycast service, which is more fully described in Internet Engineering Task Force (IETF) Request for Comment (RFC) 1546 and incorporated herein by reference in its entirety. Alternatively, the caches 109a-109n need not be in the control of the P2P provider. For example, the ISPs can deploy their own caches using this methodology without the interaction of the P2P provider—i.e., simply by knowing the Anycast IP address that is used.

FIG. 6 is a flowchart of a process for controlling access to the network caches of FIG. 1, according to an exemplary embodiment. Continuing with the example of FIG. 5, the P2P provider can determine, on for example a network by network basis, whether to provide a cache (e.g., either one of network caches 109a-109n of FIG. 1) only to its subscribers, per step 601. If the provider decides to restrict the network caches 109a-109n to its subscribers (step 603), then the network provides no route announcement (step 605) beyond its borders. Otherwise, if the provider seeks to provide the network cache 109a-109n to all users, then an appropriate route announcement provided, as in step 607.

The described processes of FIGS. 4-6 enhance network performance and reliability, while reducing complexity of cache management and device management.

The above described processes relating to cache discovery may be implemented via software, hardware (e.g., general processor, DSP chip, an application specific integrated circuit (ASIC), field programmable gate arrays (FPGAs), etc.), firmware, or a combination thereof. Such exemplary hardware for performing the described functions is detailed below.

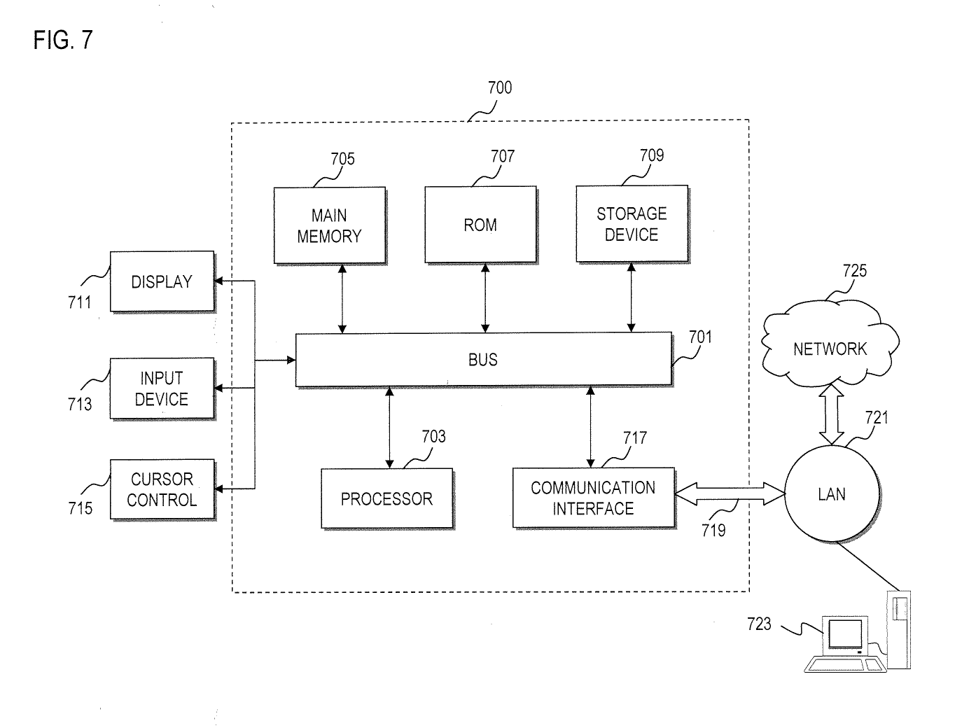

FIG. 7 illustrates a computer system 700 upon which an embodiment according to an exemplary embodiment can be implemented. For example, the processes described herein can be implemented using the computer system 700. The computer system 700 includes a bus 701 or other communication mechanism for communicating information and a processor 703 coupled to the bus 701 for processing information. The computer system 700 also includes main memory 705, such as a random access memory (RAM) or other dynamic storage device, coupled to the bus 701 for storing information and instructions to be executed by the processor 703. Main memory 705 can also be used for storing temporary variables or other intermediate information during execution of instructions by the processor 703. The computer system 700 may further include a read only memory (ROM) 707 or other static storage device coupled to the bus 701 for storing static information and instructions for the processor 703. A storage device 709, such as a magnetic disk or optical disk, is coupled to the bus 701 for persistently storing information and instructions.

The computer system 700 may be coupled via the bus 701 to a display 711, such as a cathode ray tube (CRT), liquid crystal display, active matrix display, or plasma display, for displaying information to a computer user. An input device 713, such as a keyboard including alphanumeric and other keys, is coupled to the bus 701 for communicating information and command selections to the processor 703. Another type of user input device is a cursor control 715, such as a mouse, a trackball, or cursor direction keys, for communicating direction information and command selections to the processor 703 and for controlling cursor movement on the display 711.

According to one embodiment contemplated herein, the processes described are performed by the computer system 700, in response to the processor 703 executing an arrangement of instructions contained in main memory 705. Such instructions can be read into main memory 705 from another computer-readable medium, such as the storage device 709. Execution of the arrangement of instructions contained in main memory 705 causes the processor 703 to perform the process steps described herein. One or more processors in a multi-processing arrangement may also be employed to execute the instructions contained in main memory 705. In alternative embodiments, hard-wired circuitry may be used in place of or in combination with software instructions to implement certain embodiments. Thus, the exemplary embodiments are not limited to any specific combination of hardware circuitry and software.

The computer system 700 also includes a communication interface 717 coupled to bus 701. The communication interface 717 provides a two-way data communication coupling to a network link 719 connected to a local network 721. For example, the communication interface 717 may be a digital subscriber line (DSL) card or modem, an integrated services digital network (ISDN) card, a cable modem, a telephone modem, or any other communication interface to provide a data communication connection to a corresponding type of communication line. As another example, communication interface 717 may be a local area network (LAN) card (e.g. for Ethernet™ or an Asynchronous Transfer Model (ATM) network) to provide a data communication connection to a compatible LAN. Wireless links can also be implemented. In any such implementation, communication interface 717 sends and receives electrical, electromagnetic, or optical signals that carry digital data streams representing various types of information. Further, the communication interface 717 can include peripheral interface devices, such as a Universal Serial Bus (USB) interface, a PCMCIA (Personal Computer Memory Card International Association) interface, etc. Although a single communication interface 717 is depicted in FIG. 7, multiple communication interfaces can also be employed.

The network link 719 typically provides data communication through one or more networks to other data devices. For example, the network link 719 may provide a connection through local network 721 to a host computer 723, which has connectivity to a network 725 (e.g. a wide area network (WAN) or the global packet data communication network now commonly referred to as the “Internet”) or to data equipment operated by a service provider. The local network 721 and the network 725 both use electrical, electromagnetic, or optical signals to convey information and instructions. The signals through the various networks and the signals on the network link 719 and through the communication interface 717, which communicate digital data with the computer system 700, are exemplary forms of carrier waves bearing the information and instructions.

The computer system 700 can send messages and receive data, including program code, through the network(s), the network link 719, and the communication interface 717. In the Internet example, a server (not shown) might transmit requested code belonging to an application program for implementing an exemplary embodiment through the network 725, the local network 721 and the communication interface 717. The processor 703 may execute the transmitted code while being received and/or store the code in the storage device 709, or other non-volatile storage for later execution. In this manner, the computer system 700 may obtain application code in the form of a carrier wave.

The term “computer-readable medium” as used herein refers to any medium that participates in providing instructions to the processor 703 for execution. Such a medium may take many forms, including but not limited to non-volatile media, volatile media, and transmission media. Non-volatile media include, for example, optical or magnetic disks, such as the storage device 709. Volatile media include dynamic memory, such as main memory 705. Transmission media include coaxial cables, copper wire and fiber optics, including the wires that comprise the bus 701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out various embodiments may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that flow. The specification and the drawings are accordingly to be regarded in an illustrative rather than restrictive sense.

What is claimed is:

1. A method comprising:
receiving a request from a peer node, configured to operate in a peer-to-peer environment, based on a network address assigned to a plurality of network caches;
in response to the request, determining a closest one of the network caches based on the network address.

2. A method as recited in claim 1, wherein the determination of the closest network cache is based on a routing protocol that utilizes the network address.

3. A method as recited in claim 1, further comprising:
designating the network caches to be accessible by a non-subscriber; and
generating a route announcement specifying routing information for accessing the network caches based on the designation.

4. A method as recited in claim 1, wherein the network address provides a one-to-many association, and the peer-to-peer environment is hybrid.

5. A method as recited in claim 4, wherein the network address is an Anycast address.

6. A method as recited in claim 4, wherein the network caches are maintained by one or more Internet Service Providers (ISPs).

7. A computer-readable storage medium bearing instructions that are arranged, upon execution, to cause one or more processors to perform the method of claim 1.

8. An apparatus comprising:
a communication interface configured to receive a request from a peer node, configured to operate in a peer-to-peer environment, based on a network address assigned to a plurality of network caches; and
a processor coupled to the communication interface and configured to determine, in response to the request, a closest one of the network caches based on the network address.

9. An apparatus as recited in claim 8, wherein the determination of the closest network cache is based on a routing protocol that utilizes the network address.

10. An apparatus as recited in claim 8, wherein the processor is further configured to generate a route announcement specifying routing information for accessing the network caches based on determining whether the network caches are to be accessible by a non-subscriber.

11. An apparatus as recited in claim 8, wherein the network address provides a one-to-many association, and the peer-to-peer environment is hybrid.

12. An apparatus as recited in claim 11, wherein the network address is an Anycast address.

13. An apparatus as recited in claim 11, wherein the network caches are maintained by one or more Internet Service Providers (ISPs).

14. A system comprising:
a plurality of network caches configured to store media objects, wherein the plurality of network caches is assigned a common network address; and
a router in communication with the network caches and configured to receive a request from a peer node based on the network address, wherein the router is configured to determine a closest one of the network caches based on the network address and to direct the request to the determined closest network cache.

15. A system as recited in claim 14, wherein the determination of the closest network cache is based on a routing protocol that utilizes the network address.

16. A system as recited in claim 15, wherein the determination of the closest network cache is further based on location of the request.

17. A system as recited in claim 14, wherein the router is further configured to generate a route announcement specifying routing information for accessing the network caches based on determining whether the network caches are to be accessible by a non-subscriber.

18. A system as recited in claim 14, wherein the network address provides a one-to-many association.

19. A system as recited in claim 18, wherein the network address is an Anycast address.

20. A system as recited in claim 18, wherein the network caches are maintained by one or more Internet Service Providers (ISPs).
